(19) United States
(12) Patent Application Publication
(10) Pub. No.: US 2025/0322784 A1
(43) Pub. Date: Oct. 16, 2025

(54) PIXEL CIRCUIT AND DISPLAY APPARATUS INCLUDING THE SAME

(71) Applicant: Samsung Display Co., LTD., Yongin-si (KR)

(72) Inventors: DONGWOO KIM, Yongin-si (KR); KWIHYUN KIM, Yongin-si (KR); SEHYUN LEE, Yongin-si (KR)

(21) Appl. No.: 19/014,722

(22) Filed: Jan. 9, 2025

(30) Foreign Application Priority Data
Apr. 12, 2024 (KR) 10-2024-0049575

(51) Int. Cl. G09G 3/32

(52) U.S. Cl. CPC G09G 3/32; G09G 2310/0267; G09G 2310/0275; G09G 2310/08; G09G 2330/021

(57) ABSTRACT

A pixel circuit includes a first transistor including a control electrode connected to a first node, a first electrode connected to a second node and a second electrode connected to a third node, a second transistor which applies a data voltage to the first transistor, a third transistor connected to the first node and the third node, a seventh transistor connected to a fourth node, where the seventh transistor applies a driving current to a light emitting element, a ninth transistor which applies a constant-current voltage to the fourth node and the light emitting element which emits a light based on the data voltage and the constant-current voltage. The first transistor is a P-type transistor, the second transistor is an N-type transistor, the third transistor is an N-type transistor, and the seventh transistor is a P-type transistor.

This application claims priority to Korean Patent Application No. 10-2024-0049575, filed on Apr. 12, 2024, and all the benefits accruing therefrom under 35 U.S.C. § 119, the content of which in its entirety is herein incorporated by reference.

### BACKGROUND

### 1. Field

Embodiments of the invention relate to a pixel circuit and a display apparatus including the pixel circuit. More particularly, embodiments of the invention relate to a pixel circuit driven in a pulse width modulation method, operating an internal compensation of a threshold voltage, including fewer transistors, and thus, applicable to a ultra-high resolution display apparatus and a display apparatus including the pixel circuit.

### 2. Description of the Related Art

Generally, a display apparatus includes a display panel and a display panel driver. The display panel includes a plurality of gate lines, a plurality of data lines and a plurality of pixels. The display panel driver may include a gate driver, a data driver and a driving controller. The gate driver may output gate signals to the gate lines. The data driver may output data voltages to the data lines. The driving controller may control the gate driver and the data driver.

A conventional pixel circuit driven in a pulse width modulation method and operating internal compensation of the threshold voltage typically includes nineteen or more transistors and three or more capacitors. If the pixel circuit includes nineteen or more transistors and three or more capacitors, the pixel circuit may not be effectively applied to an ultra-high resolution display apparatus due to a limitation in integration.

### SUMMARY

Embodiments of the invention provide a pixel circuit which is driven in a pulse width modulation method, operates an internal compensation of a threshold voltage and includes fewer transistors, and thus, applicable to a ultra-high resolution display apparatus.

Embodiments of the invention also provide a display apparatus including the pixel circuit.

In an embodiment of a pixel circuit according to the invention, the pixel circuit includes a first transistor, a second transistor, a third transistor, a seventh transistor, a ninth transistor and a light emitting element. In such an embodiment, the first transistor includes a control electrode connected to a first node, a first electrode connected to a second node and a second electrode connected to a third node. In such an embodiment, the second transistor applies a data voltage to the first transistor. In such an embodiment, the third transistor is connected to the first node and the third node. In such an embodiment, the seventh transistor is connected to a fourth node and applies a driving current to a light emitting element. In such an embodiment, the ninth transistor applies a constant-current voltage to the fourth node. In such an embodiment, the light emitting element emits a light based on the data voltage and the constant-current voltage. In such an embodiment, the first transistor is a P-type transistor, the second transistor is an N-type transistor, the third transistor is an N-type transistor, and the seventh transistor is a P-type transistor.

In an embodiment, the pixel circuit may further include a sixth transistor including a control electrode which receives a first initialization signal, a first electrode connected to the first node and a second electrode connected to a first initialization voltage terminal.

In an embodiment, the pixel circuit may further include a first capacitor including a first electrode which receives a sweep signal and a second electrode connected to the first node.

In an embodiment, the pixel circuit may further include a fourth transistor including a control electrode which receives an emission signal, a first electrode which receives a first power voltage and a second electrode connected to the second node and a fifth transistor including a control electrode which receives the emission signal, a first electrode connected to the third node and a second electrode connected to the fourth node.

In an embodiment, the pixel circuit may further include an eighth transistor including a control electrode which receives an emission signal, a first electrode connected to a second electrode of the seventh transistor and a second electrode connected to an anode electrode of the light emitting element.

In an embodiment, the pixel circuit may further include an eighth transistor including a control electrode which receives an emission signal, a first electrode which receives a second power voltage and a second electrode connected to a first electrode of the seventh transistor.

In an embodiment, the pixel circuit may further include a tenth transistor including a control electrode which receives a second initialization signal, a first electrode connected to an anode electrode of the light emitting element and a second electrode which receives a second initialization voltage.

In an embodiment, the pixel circuit may further include a second capacitor including a first electrode which receives a second power voltage and a second electrode connected to the fourth node.

In an embodiment, the second transistor may include a control electrode which receives a first scan signal, a first electrode which receives the data voltage and a second electrode connected to the second node. In such an embodiment, The third transistor may include a control electrode which receives the first scan signal, a first electrode connected to the first node and a second electrode connected to the third node. In such an embodiment, the seventh transistor may include a control electrode connected to the fourth node, a first electrode which receives a second power voltage and a second electrode connected to a fifth node. In such an embodiment, the ninth transistor may include a control electrode which receives a second scan signal, a first electrode connected to the fourth node and a second electrode connected to a first initialization voltage terminal. In such an embodiment, the light emitting element may include an anode electrode connected to the fifth node and a cathode electrode which receives a third power voltage. In such an embodiment, the pixel may further include a fourth transistor including a control electrode which receives an emission signal, a first electrode which receives a first power voltage and a second electrode connected to the second node, a fifth transistor including a control electrode which receives the emission signal, a first electrode connected to the third node and a second electrode connected to the fourth node, a sixth transistor including a control electrode which receives a first initialization signal, a first electrode connected to the first node and a second electrode connected to the first initialization voltage terminal, an eighth transistor including a control electrode which receives the emission signal, a first electrode connected to the fifth node and a second electrode connected to the anode electrode of the light emitting element, a tenth transistor including a control electrode which receives a second initialization signal, a first electrode connected to the anode electrode of the light emitting element and a second electrode which receives a second initialization voltage, a first capacitor including a first electrode which receives a sweep signal and a second electrode connected to the first node and a second capacitor including a first electrode which receives the second power voltage and a second electrode connected to the fourth node.

In an embodiment, the sixth transistor and the ninth transistor may be N-type transistors, and the fourth transistor, the fifth transistor, the eighth transistor and the tenth transistor may be P-type transistors.

In an embodiment, the first initialization signal may have an active level in a first period, the second initialization signal may have an active level in the first period, the first scan signal may have an inactive level in the first period, the second scan signal may have an active level in the first period, the emission signal may have an inactive level in the first period, and the sweep signal may have a high level in the first period. In such an embodiment, a voltage outputted from the first initialization voltage terminal may have a first level in the first period.

In an embodiment, the first initialization signal may have an inactive level in a second period, the second initialization signal may have an active level in the second period, the first scan signal may have an active pulse in the second period, the second scan signal may have an inactive level in the second period, the emission signal may have an inactive level in the second period, and the sweep signal may have a high level in the second period.

In an embodiment, the first initialization signal may have an inactive level in a third period, the second initialization signal may have an active level in the third period, the first scan signal may have an inactive level in the third period, the second scan signal may have an active level in the third period, the emission signal may have an inactive level in the third period, and the sweep signal may have a high level in the third period. In such an embodiment, a voltage outputted from the first initialization voltage terminal may have a second level in the third period.

In an embodiment, the first initialization signal may have an inactive level in a fourth period and a fifth period, the second initialization signal may have an inactive level in the fourth period and the fifth period, the first scan signal may have an inactive level in the fourth period and the fifth period, the second scan signal may have an inactive level in the fourth period and the fifth period, and the emission signal may have an active level in the fourth period and the fifth period. In such an embodiment, the sweep signal may gradually decrease from a high level in the fourth period and the fifth period.

In an embodiment, the second scan signal may have an inactive level in a first period. In such an embodiment, the second scan signal may have the inactive level in a second period subsequent to the first period. In such an embodiment, the second scan signal may have an active level in a third period subsequent to the second period.

In an embodiment, the second scan signal may have an active level in a first period. In such an embodiment, the second scan signal may have the active level in a second period subsequent to the first period. In such an embodiment, the second scan signal may have the active level in a third period subsequent to the second period.

In an embodiment, the data voltage may be applied to the first transistor and the light emitting element emits a light in a writing frame. In such an embodiment, the first initialization signal may have an active level in a first period of the writing frame. In such an embodiment, the first scan signal may have an active pulse in a second period of the writing frame. In such an embodiment, the data voltage may not be applied to the first transistor and the light emitting element emits a light in a holding frame. In such an embodiment, the first initialization signal may have an inactive level in a first period of the holding frame. In such an embodiment, the first scan signal may have an inactive level in a second period of the holding frame.

In an embodiment, the first initialization signal, the second initialization signal, the first scan signal, the second scan signal, the emission signal and the sweep signal may be sequentially applied to pixel rows.

In an embodiment, the pixel circuit may further include a fourth transistor including a control electrode which receives an emission signal, a first electrode which receives a first power voltage and a second electrode connected to the second node. In such an embodiment, a second power voltage may be applied to a first electrode of the seventh transistor. In such an embodiment, the first power voltage may be greater than the second power voltage. In such an embodiment, the pixel circuit may further include a tenth transistor including a control electrode which receives a second initialization voltage, a first electrode connected to an anode electrode of the light emitting element and a second electrode which receives a second initialization voltage. In such an embodiment, a third power voltage may be applied to a cathode electrode of the light emitting element. In such an embodiment, the second initialization voltage may be less than the third power voltage.

In an embodiment of a display apparatus according to the invention, the display apparatus includes a display panel, a gate driver and a data driver. In such an embodiment, the display panel includes a pixel circuit. In such an embodiment, the gate driver outputs a gate signal to the pixel circuit. In such an embodiment, the data driver outputs a data voltage to the pixel circuit. In such an embodiment, the pixel circuit includes a first transistor including a control electrode connected to a first node, a first electrode connected to a second node and a second electrode connected to a third node, a second transistor which applies the data voltage to the first transistor, a third transistor connected to the first node and the third node, a seventh transistor connected to a fourth node, where the seventh transistor applies a driving current to a light emitting element, a ninth transistor which applies a constant-current voltage to the fourth node and the light emitting element which emits a light based on the data voltage and the constant-current voltage. In such an embodiment, the first transistor is a P-type transistor, the second transistor is an N-type transistor, the third transistor is an N-type transistor, and the seventh transistor is a P-type transistor.

According to embodiments of the pixel circuit and the display apparatus including the pixel circuit, the pixel circuit may include ten transistors and two capacitors. In such embodiments, the pixel circuit may be driven in the pulse width modulation method, operate the internal compensation of the threshold voltage and include the relatively fewer transistors compared to the conventional pixel circuit, such that the high integration may be achieved. Thus, the pixel circuit may be applicable to an ultra-high resolution display apparatus.

In embodiments, at least one transistor in the pulse width modulation circuit and at least one transistor in the constant current generating circuit may be N-type transistors such that a power consumption may be reduced.

In embodiments, a threshold voltage compensation circuit is removed from the constant current generating circuit such that the number of the transistors may be reduced.

In embodiments, the driving transistor of the pulse width modulation circuit and the driving transistor of the constant current generating circuit may be P-type transistors such that a mobility may be enhanced.

In embodiments, the second initialization voltage applied to the second electrode of the tenth transistor is less than the third power voltage applied to the cathode electrode of the light emitting element such that a black characteristic of the pixel circuit may be enhanced.

In embodiments, the first initialization voltage applied to the control electrode of the first transistor and a constant-current voltage applied to the control electrode of the seventh transistor are outputted from a same voltage terminal such that a number of transistors and a number of signal lines may be reduced.

### BRIEF DESCRIPTION OF THE DRAWINGS

The above and other features of embodiments of the invention will become more apparent by describing in detailed embodiments thereof with reference to the accompanying drawings, in which:

FIG. 1 is a block diagram illustrating a display apparatus according to an embodiment of the invention;

FIG. 2 is a circuit diagram illustrating a pixel circuit of the display panel of FIG. 1;

FIG. 3 is a circuit diagram illustrating an operation of the pixel circuit of FIG. 2 in a first period of a driving timing;

FIG. 4 is a signal timing diagram illustrating an example of input signals applied to the pixel circuit of FIG. 2 and node signals of the pixel circuit of FIG. 2 in the first period;

FIG. 5 is a circuit diagram illustrating an operation of the pixel circuit of FIG. 2 in a second period of the driving timing;

FIG. 6 is a signal timing diagram illustrating an example of input signals applied to the pixel circuit of FIG. 2 and node signals of the pixel circuit of FIG. 2 in the second period;

FIG. 7 is a circuit diagram illustrating an operation of the pixel circuit of FIG. 2 in a third period of the driving timing;

FIG. 8 is a signal timing diagram illustrating an example of input signals applied to the pixel circuit of FIG. 2 and node signals of the pixel circuit of FIG. 2 in the third period;

FIG. 9 is a circuit diagram illustrating an operation of the pixel circuit of FIG. 2 in a fourth period of the driving timing;

FIG. 10 is a signal timing diagram illustrating an example of input signals applied to the pixel circuit of FIG. 2 and node signals of the pixel circuit of FIG. 2 in the fourth period;

FIG. 11 is a circuit diagram illustrating an operation of the pixel circuit of FIG. 2 in a fifth period of the driving timing;

FIG. 12 is a signal timing diagram illustrating an example of input signals applied to the pixel circuit of FIG. 2 and node signals of the pixel circuit of FIG. 2 in the fifth period;

FIG. 13 is a signal timing diagram illustrating an example of input signals applied to the pixel circuit of FIG. 2 and node signals of the pixel circuit of FIG. 2;

FIG. 14 is a signal timing diagram illustrating an example of input signals applied to the pixel circuit of FIG. 2 and node signals of the pixel circuit of FIG. 2;

FIG. 15 is a diagram illustrating a driving frequency of the display panel of FIG. 1;

FIG. 16 is a signal timing diagram illustrating an example of input signals applied to the pixel circuit of FIG. 2 and node signals of the pixel circuit of FIG. 2 in a writing frame;

FIG. 17 is a signal timing diagram illustrating an example of input signals applied to the pixel circuit of FIG. 2 and node signals of the pixel circuit of FIG. 2 in a holding frame;

FIG. 18 is a signal timing diagram illustrating an example of input signals applied to the pixel circuit of FIG. 2 and node signals of the pixel circuit of FIG. 2;

FIG. 19 is a circuit diagram illustrating a pixel circuit of a display panel of a display apparatus according to an embodiment of the invention;

FIG. 20 is a block diagram illustrating an electronic apparatus according to an embodiment of the invention;

FIG. 21 is a diagram illustrating an example in which the electronic apparatus of FIG. 20 is implemented as a smart phone; and

FIG. 22 is a diagram illustrating an example in which the electronic apparatus of FIG. 20 is implemented as a smart watch.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of the invention will be described in detail with reference to the accompanying drawings.

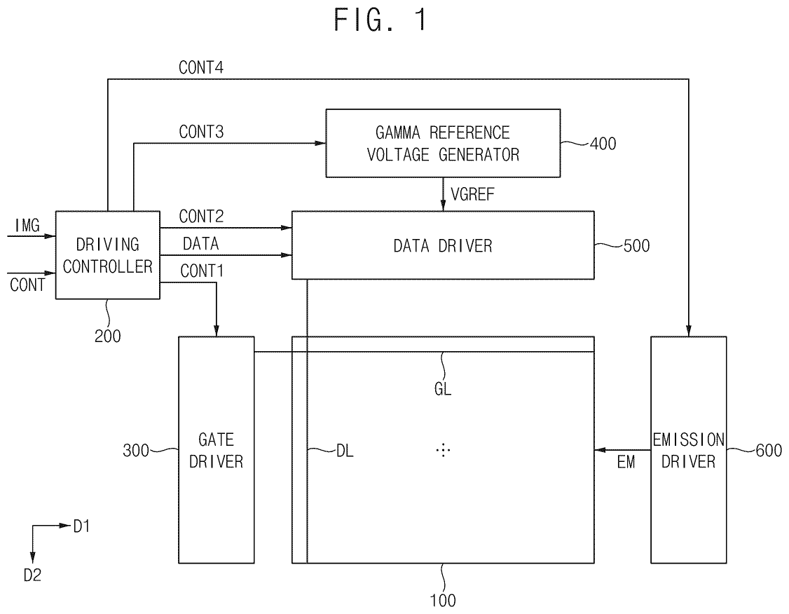

FIG. 1 is a block diagram illustrating a display apparatus according to an embodiment of the invention.

Referring to FIG. 1, an embodiment of the display apparatus includes a display panel 100 and a display panel driver. The display panel driver includes a driving controller 200, a gate driver 300, a gamma reference voltage generator 400 and a data driver 500. The display panel driver may further include an emission driver 600.

The display panel 100 includes a display region, on which an image is displayed, and a peripheral region adjacent to the display region.

The display panel 100 includes a plurality of gate lines GL, a plurality of data lines DL and a plurality of pixels electrically connected to the gate lines GL and the data lines DL. In an embodiment, the gate lines GL may extend in a first direction D1 and the data lines DL may extend in a second direction D2 crossing the first direction D1. In such an embodiment, a display surface of the display panel 100 may be disposed on a plane defined by the first direction D1 and the second direction D2.

The driving controller 200 receives input image data IMG and an input control signal CONT from an external apparatus. In an embodiment, for example, the input image data IMG may include red image data, green image data and blue image data. The input image data IMG may include white image data. The input image data IMG may include magenta image data, cyan image data and yellow image data. The input control signal CONT may include a master clock signal and a data enable signal. The input control signal CONT may further include a vertical synchronizing signal and a horizontal synchronizing signal.

The driving controller 200 generates a first control signal CONT1, a second control signal CONT2, a third control signal CONT3, a fourth control signal CONT4 and a data signal DATA based on the input image data IMG and the input control signal CONT.

The driving controller 200 generates the first control signal CONT1 for controlling an operation of the gate driver 300 based on the input control signal CONT, and outputs the first control signal CONT1 to the gate driver 300. The first control signal CONT1 may include a vertical start signal and a gate clock signal.

The driving controller 200 generates the second control signal CONT2 for controlling an operation of the data driver 500 based on the input control signal CONT, and outputs the second control signal CONT2 to the data driver 500. The second control signal CONT2 may include a horizontal start signal and a load signal.

The driving controller 200 generates the data signal DATA based on the input image data IMG. The driving controller 200 outputs the data signal DATA to the data driver 500.

The driving controller 200 generates the third control signal CONT3 for controlling an operation of the gamma reference voltage generator 400 based on the input control signal CONT, and outputs the third control signal CONT3 to the gamma reference voltage generator 400.

The driving controller 200 generates the fourth control signal CONT4 for controlling an operation of the emission driver 600 based on the input control signal CONT, and outputs the fourth control signal CONT4 to the emission driver 600.

The gate driver 300 generates gate signals driving the gate lines GL in response to the first control signal CONT1 received from the driving controller 200. The gate driver 300 may output the gate signals to the gate lines GL.

In an embodiment of the invention, the gate driver 300 may be integrated on the peripheral region of the display panel 100. In an embodiment of the invention, the gate driver 300 may be mounted on the peripheral region of the display panel 100.

The gamma reference voltage generator 400 generates a gamma reference voltage VGREF in response to the third control signal CONT3 received from the driving controller 200. The gamma reference voltage generator 400 provides the gamma reference voltage VGREF to the data driver 500. The gamma reference voltage VGREF has a value corresponding to a level of the data signal DATA.

In an embodiment, the gamma reference voltage generator 400 may be disposed in the driving controller 200, or in the data driver 500.

The data driver 500 receives the second control signal CONT2 and the data signal DATA from the driving controller 200, and receives the gamma reference voltages VGREF from the gamma reference voltage generator 400. The data driver 500 converts the data signal DATA into data voltages having an analog type using the gamma reference voltages VGREF. The data driver 500 outputs the data voltages to the data lines DL.

In an embodiment of the invention, the data driver 500 may be integrated on the peripheral region of the display panel 100. In an embodiment of the invention, the data driver 500 may be mounted on the peripheral region of the display panel 100.

The emission driver 600 generates emission signals EM in response to the fourth control signal CONT4 received from the driving controller 200. The emission driver 600 may output the emission signals EM to the display panel 100.

In an embodiment of the invention, the emission driver 600 may be integrated on the peripheral region of the display panel 100. In an embodiment of the invention, the emission driver 600 may be mounted on the peripheral region of the display panel 100.

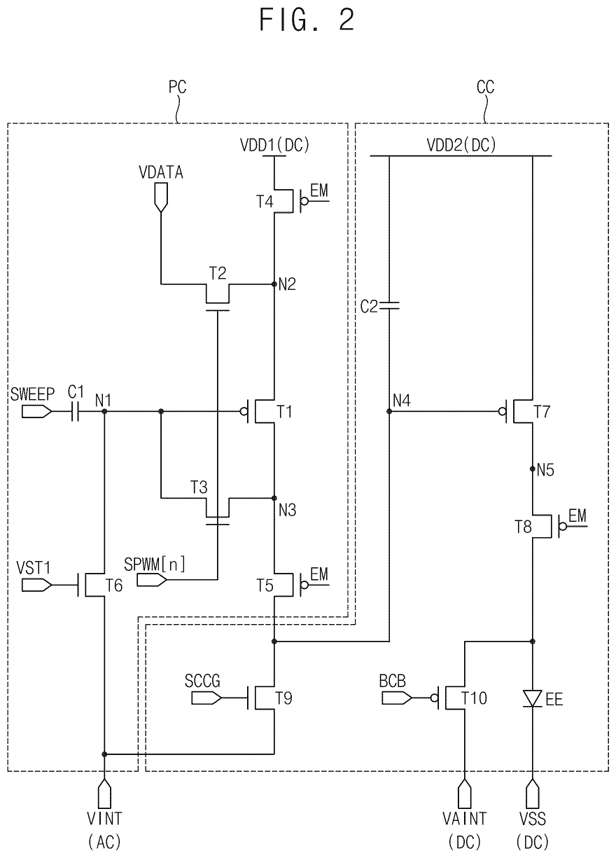

FIG. 2 is a circuit diagram illustrating a pixel circuit of the display panel 100 of FIG. 1.

Referring to FIGS. 1 and 2, an embodiment of the pixel circuit may include a first circuit PC and a second circuit.

The first circuit PC may be a pulse width modulation circuit for a pulse width modulation (PWM). The second circuit CC may be a constant current generating circuit for a constant current generation (CCG).

The first circuit PC may include first to sixth transistors T1, T2, T3, T4, T5 and T6 and a first capacitor C1. The second circuit CC may include seventh to tenth T7, T8, T9 and T10 and a second capacitor C2. The second circuit CC may include a light emitting element EE.

In an embodiment, the light emitting element EE may be a light emitting diode. In an embodiment, for example, the light emitting element EE may be a micro light emitting diode.

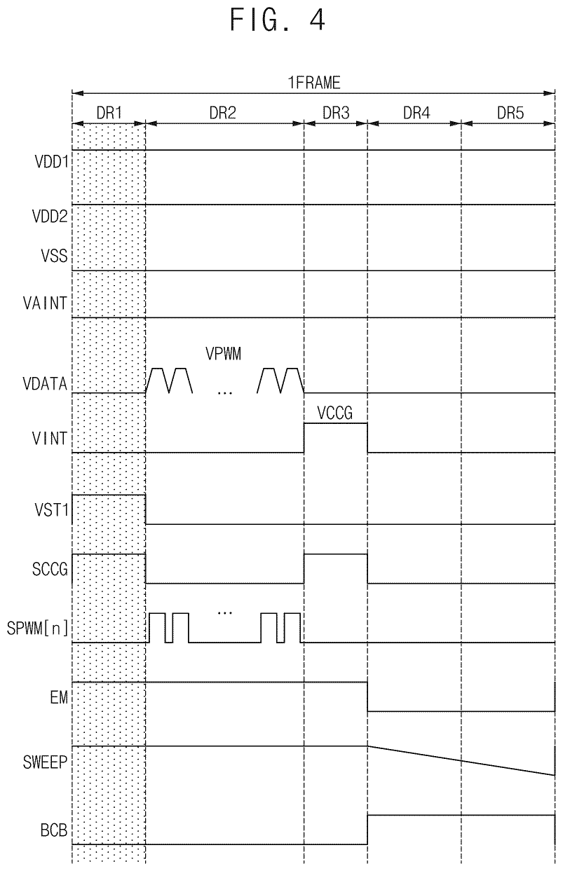

The pixel circuit includes the first transistor T1, the second transistor T2, the third transistor T3, the seventh transistor T7, the ninth transistor T9 and the light emitting element EE. The first transistor T1 includes a control electrode connected to a first node N1, a first electrode connected to a second node N2 and a second electrode connected to a third node N3. The second transistor T2 applies a data voltage (VPWM of FIG. 4) to the first transistor T1. The third transistor T3 is connected to the first node N1 and the third node N3. The seventh transistor T7 is connected to a fourth node N4 and applies a driving current to the light emitting element EE. The ninth transistor T9 applies a constant-current voltage (VCCG of FIG. 4) to the fourth node N4. The light emitting element EE emits a light based on the data voltage (VPWM of FIG. 4) and the constant-current voltage (VCCG of FIG. 4).

The first transistor T1 is a P-type transistor. The seventh transistor T7 is a P-type transistor. The second transistor T2 is an N-type transistor. The third transistor T3 is an N-type transistor.

The second transistor T2 may include a control electrode that receives a first scan signal SPWM[n], a first electrode that receives the data voltage VDATA and a second electrode connected to the second node N2.

The third transistor T3 may include a control electrode that receives the first scan signal SPWM[n], a first electrode connected to the first node N1 and a second electrode connected to the third node N3.

The seventh transistor T7 may include a control electrode connected to the fourth node N4, a first electrode that receives a second power voltage VDD2 and a second electrode connected to a fifth node N5.

The ninth transistor T9 may include a control electrode that receives a second scan signal SCCG, a first electrode connected to the fourth node N4 and a second electrode connected to a first initialization voltage terminal.

The light emitting element EE may include an anode electrode connected to the fifth node N5 and a cathode electrode. The cathode electrode may receive a third power voltage VSS.

The fourth transistor T4 may include a control electrode that receives the emission signal EM, a first electrode that receives a first power voltage VDD1 and a second electrode connected to the second node N2.

The fifth transistor T5 may include a control electrode that receives the emission signal EM, a first electrode connected to the third node N3 and a second electrode connected to the fourth node N4.

The sixth transistor T6 may include a control electrode that receives a first initialization signal VST1, a first electrode connected to the first node N1 and a second electrode connected to the first initialization voltage terminal.

The eighth transistor T8 may include a control electrode that receives the emission signal EM, a first electrode connected to the fifth node N5 and a second electrode connected to the anode electrode of the light emitting element EE.

The tenth transistor T10 may include a control electrode that receives a second initialization signal BCB, a first electrode connected to the anode electrode of the light emitting element EE and a second electrode that receives a second initialization voltage VAINT.

The first capacitor C1 may include a first electrode that receives a sweep signal SWEEP and a second electrode connected to the first node N1.

The second capacitor C2 may include a first electrode that receives the second power voltage VDD2 and a second electrode connected to the fourth node N4.

As described above, the pixel circuit may include ten transistors and two capacitors.

In an embodiment, for example, the sixth transistor T6 and the ninth transistor T9 may be N-type transistors. In such an embodiment, the fourth transistor T4, the fifth transistor T5, the eighth transistor T8 and the tenth transistor T10 may be P-type transistors.

In an embodiment, some of the transistors in the pixel circuit may be P-type transistors and some of the transistors in the pixel circuit may be N-type transistors. In an embodiment, for example, the P-type transistor may be a low temperature polycrystalline silicon (LTPS) transistor. In an embodiment, for example, the N-type transistor may be an oxide semiconductor transistor. The third transistor T3, the sixth transistor T6 and the ninth transistor T9 may be N-type transistors such that a current leakage at the third transistor T3, the sixth transistor T6 and the ninth transistor T9 may be reduced and accordingly the pixel circuit may be stably operated even when using a relatively low power voltage. Thus, the power consumption of the display apparatus may be reduced by using N-type transistors for the third transistor T3, the sixth transistor T6 and the ninth transistor T9.

In an embodiment, a first initialization voltage applied to the control electrode of the first transistor T1 and a constant-current voltage applied to the control electrode of the seventh transistor T7 are outputted from the same voltage terminal VINT such that a number of the transistors and a number of the signal lines may be reduced.

In an embodiment, the data voltage (VPWM of FIG. 4) may have same or different voltage levels depending on intensities of light emission of pixels. In such an embodiment, the constant-current voltage (VCCG of FIG. 4) may have a same voltage level for all pixels. Alternatively, the constant-current voltage (VCCG of FIG. 4) may have a first voltage level for red pixels, a second voltage level different from the first voltage level for green pixels and a third voltage level different from the first voltage level and the second voltage level for blue pixels.

In an embodiment, for example, the first power voltage VDD1 and the second power voltage VDD2 may be high power voltages for determining a light emission degree of the light emitting element EE and the third power voltage VSS may be a low power voltage for determining the light emission degree of the light emitting element EE. The first power voltage VDD1 and the second power voltage VDD2 may be greater than the third power voltage VSS.

In addition, the first power voltage VDD1 may be greater than the second power voltage VDD2.

When the first transistor T1 is turned off and the seventh transistor T7 is turned on in a light emission period, the light emitting element EE may emit a light. When the first transistor T1 is turned on, and accordingly, the first power voltage VDD1 is applied to the control electrode of the seventh transistor T7 in a light emission off period, the seventh transistor T7 may be turned off and the light emitting element EE may stop emitting a light.

In an embodiment, the first power voltage VDD1 may be greater than the second power voltage VDD2, such that the seventh transistor T7 may be maintained in a turned-off state more reliably when the first power voltage VDD1 is applied to the control electrode of the seventh transistor T7.

In an embodiment, for example, the second initialization voltage VAINT may be less than the third power voltage VSS. In such an embodiment where the second initialization voltage VAINT is less than the third power voltage VSS, a leakage current may be effectively prevented from flowing through the light emitting element EE. Thus, a black characteristic of the pixel circuit may be enhanced.

In an embodiment, the first scan signal SPWM[n] may be a progressive scan signal having different timings for pixel rows. Here, ‘n’ is a natural number, and [n] represents an n-th pixel row. The pixel circuit of FIG. 2 that receives the first scan signal SPWM[n] may be a pixel circuit included in the n-th pixel row.

The first initialization signal VST1, the second initialization signal BCB and the second scan signal SCCG may be global scan signals having a same timing regardless of the pixel row. In addition, the emission signal EM may be a global scan signal having a same timing regardless of the pixel row.

The first power voltage VDD1, the second power voltage VDD2, the third power voltage VDD3 and the second initialization voltage VAINT may be direct-current voltages. In contrast, the voltage outputted from the first initialization voltage terminal may be an alternating voltage. In an embodiment, for example, the voltage outputted from the first initialization voltage terminal may have a first level and a second level. The first level may be the first initialization voltage applied to the control electrode of the first transistor T1. The second level may be the constant-current voltage (VCCG of FIG. 4) applied to the control electrode of the seventh transistor T7.

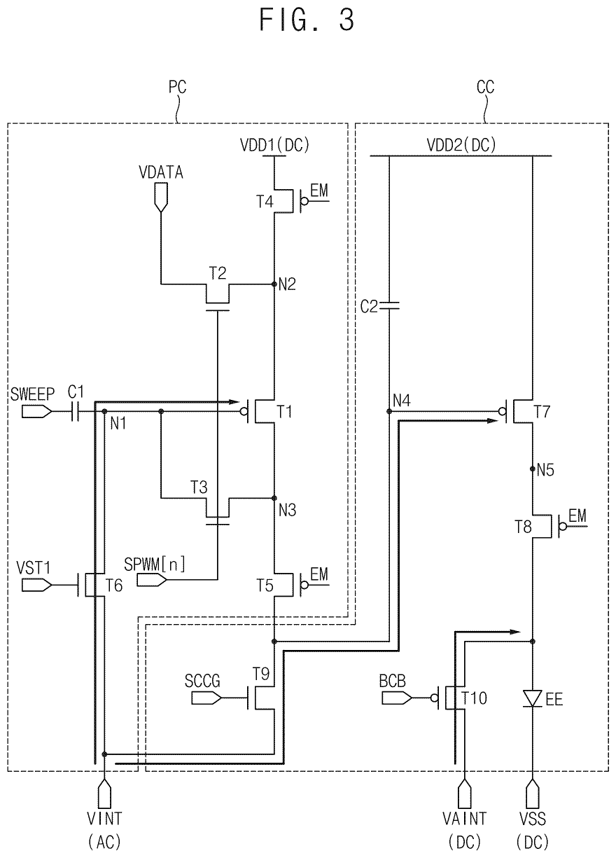

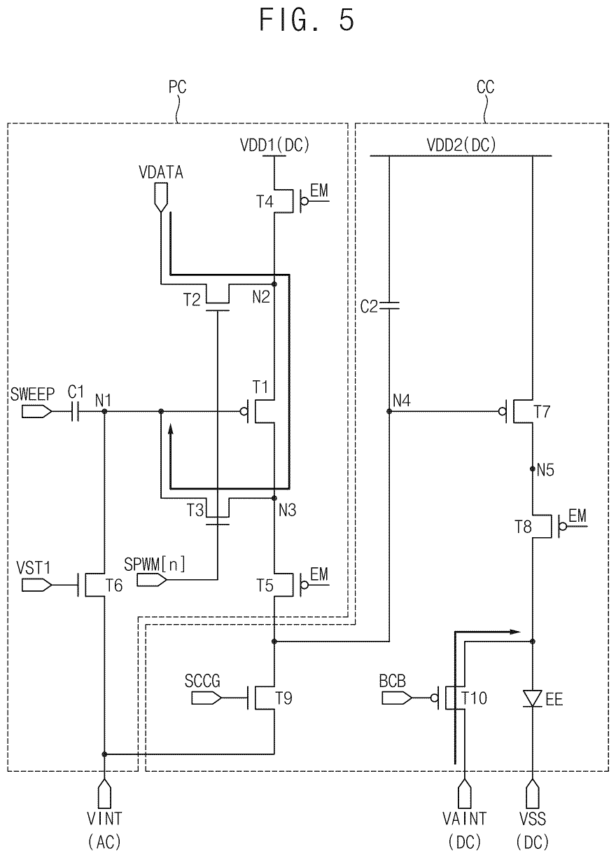

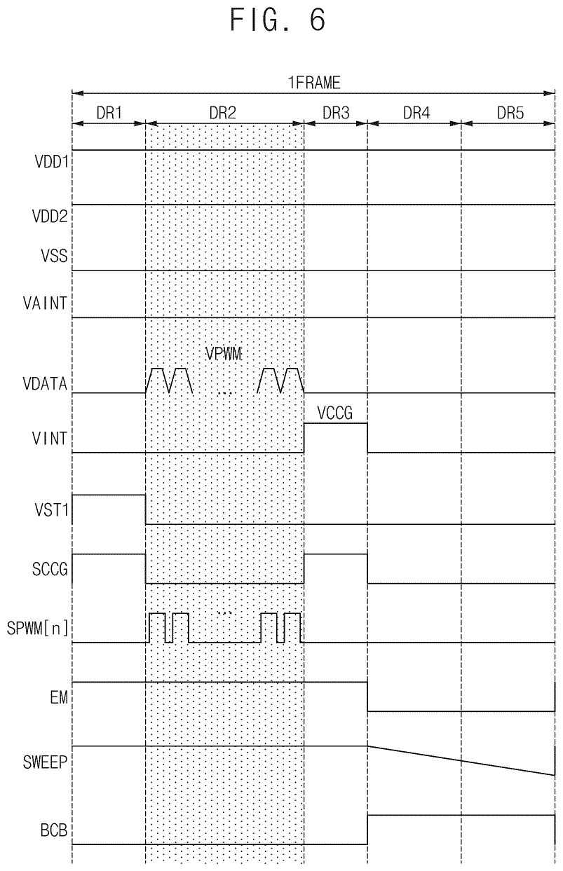

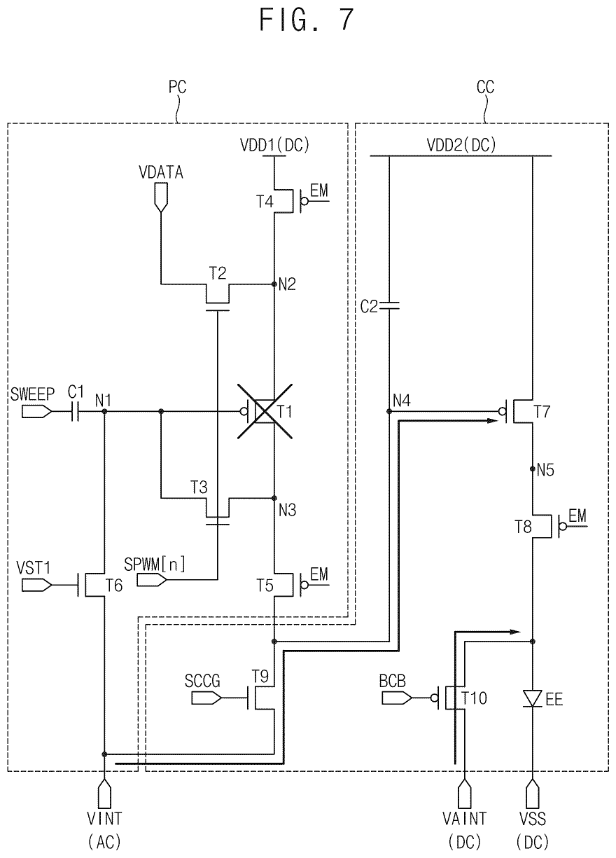

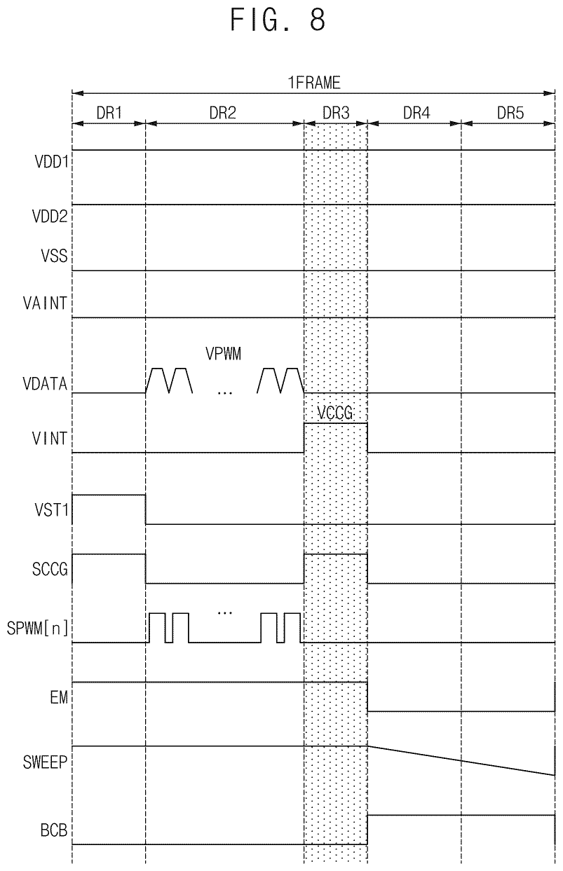

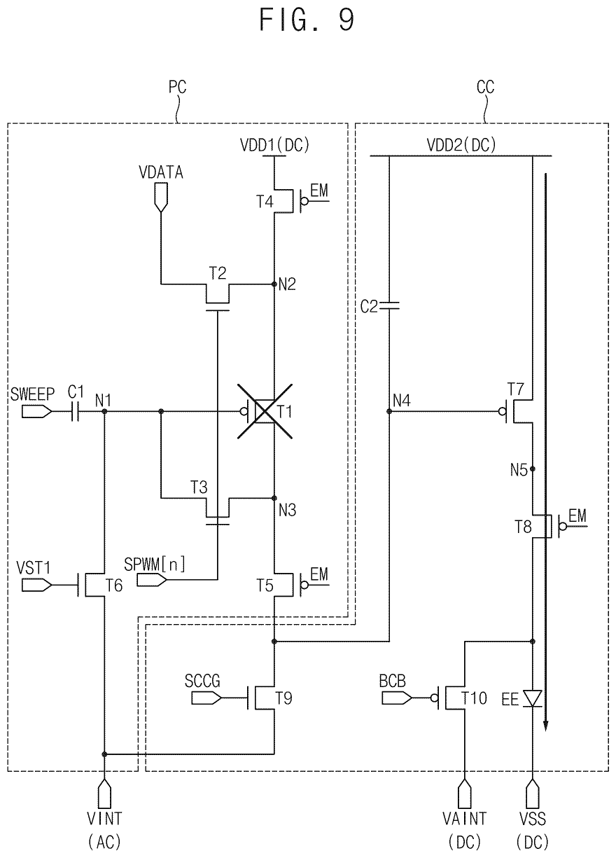

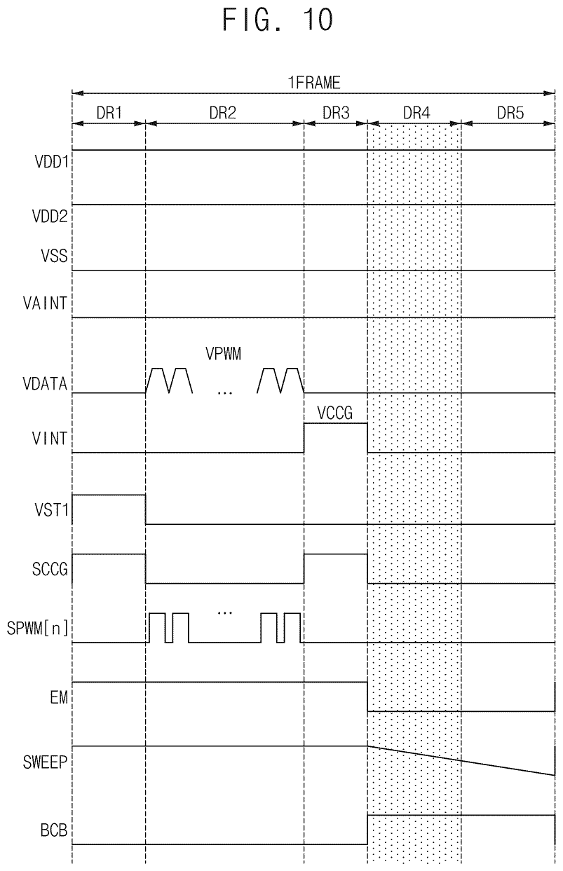

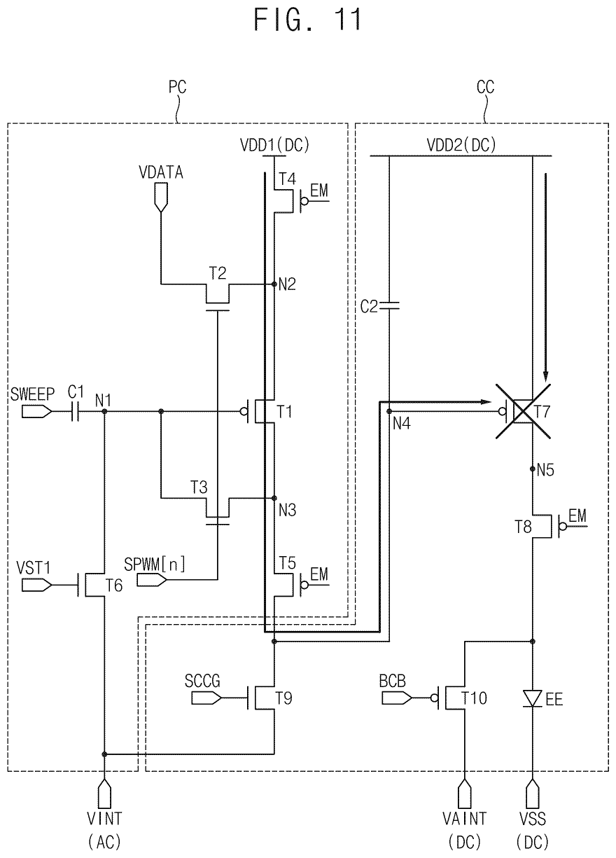

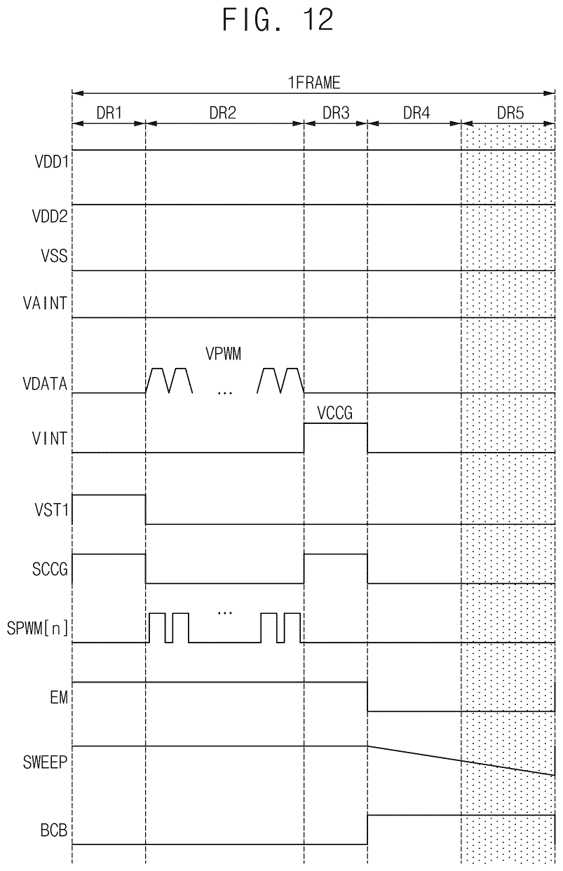

FIG. 3 is a circuit diagram illustrating an operation of the pixel circuit of FIG. 2 in a first period DR1 of a driving timing. FIG. 4 is a signal timing diagram illustrating an example of input signals applied to the pixel circuit of FIG. 2 and node signals of the pixel circuit of FIG. 2 in the first period DR1. FIG. 5 is a circuit diagram illustrating an operation of the pixel circuit of FIG. 2 in a second period DR2 of the driving timing. FIG. 6 is a signal timing diagram illustrating an example of input signals applied to the pixel circuit of FIG. 2 and node signals of the pixel circuit of FIG. 2 in the second period DR2. FIG. 7 is a circuit diagram illustrating an operation of the pixel circuit of FIG. 2 in a third period DR3 of the driving timing. FIG. 8 is a signal timing diagram illustrating an example of input signals applied to the pixel circuit of FIG. 2 and node signals of the pixel circuit of FIG. 2 in the third period DR3. FIG. 9 is a circuit diagram illustrating an operation of the pixel circuit of FIG. 2 in a fourth period DR4 of the driving timing. FIG. 10 is a signal timing diagram illustrating an example of input signals applied to the pixel circuit of FIG. 2 and node signals of the pixel circuit of FIG. 2 in the fourth period DR4. FIG. 11 is a circuit diagram illustrating an operation of the pixel circuit of FIG. 2 in a fifth period DR5 of the driving timing FIG. 12 is a signal timing diagram illustrating an example of input signals applied to the pixel circuit of FIG. 2 and node signals of the pixel circuit of FIG. 2 in the fifth period DR5.

In the driving timing, the first period DR1 may be an initialization period, the second period DR2 may be a pulse width modulation data writing and compensation period, the third period DR3 may be a constant-current voltage writing period, the fourth period DR4 may be the light emission period, and the fifth period DR5 may be the light emission off period.

A width of the fourth period DR4, which is the light emission period, may be determined by a level of the pulse width modulation data VPWM.

The sweep signal SWEEP may have a constant high level in the first period DR1, the second period DR2 and the third period DR3 and may gradually decrease in the fourth period DR4 and the fifth period DR5.

Referring to FIGS. 3 and 4, in the first period DR1, the first initialization signal VST1 may have an active level, the second initialization signal BCB may have an active level, the first scan signal SPWM[n] may have an inactive level, the second scan signal SCCG may have an active level, the emission signal EM may have an inactive level, the sweep signal SWEEP may have the high level and the voltage outputted from the first initialization voltage terminal may have the first level (the first initialization voltage).

In an embodiment, where the transistor that receives the first initialization signal VST1, the second initialization signal BCB, the first scan signal SPWM[n], the second scan signal SCCG and the emission signal EM is a P-type transistor, the active level may be a low level and the inactive level may be a high level. In an embodiment, where the transistor that receives the first initialization signal VST1, the second initialization signal BCB, the first scan signal SPWM[n], the second scan signal SCCG and the emission signal EM is an N-type transistor, the active level may be a high level and the inactive level may be a low level.

The first period DR1 may be the initialization period. In the initialization period DR1, the sixth transistor T6, the ninth transistor T9 and the tenth transistor T10 may be turned on.

In the initialization period DR1, the control electrode (the first node N1) of the first transistor T1 may be initialized by the first initialization voltage through the sixth transistor T6. The first initialization voltage may be a level to turn on the first transistor T1. In the initialization period DR1, the control electrode (the fourth node N4) of the seventh transistor T7 may be initialized by the first initialization voltage through the ninth transistor T9. The first initialization voltage may be a level to turn off the seventh transistor T7. In the initialization period DR1, the anode electrode of the light emitting element EE may be initialized by the second initialization voltage VAINT through the tenth transistor T10.

Referring to FIGS. 5 and 6, in the second period DR2 subsequent to the first period DR1, the first initialization signal VST1 may have an inactive level, the second initialization signal BCB may have the active level, the first scan signal SPWM[n] may have an active pulse, the second scan signal SCCG may have an inactive level, the emission signal EM may have the inactive level and the sweep signal SWEEP may have the high level.

The second period DR2 may be the pulse width modulation data writing and compensation period. In the pulse width modulation data writing and compensation period DR2, the second transistor T2 may be turned on by the first scan signal SPWM[n], the first transistor T1 may be turned on by the first initialization voltage in the initialization period DR1 and the third transistor T3 may be turned on by the first scan signal SPWM[n]. In the pulse width modulation data writing and compensation period DR2, a turned-on state of the tenth transistor T10 may be maintained.

In the pulse width modulation data writing and compensation period DR2, the data voltage VPWM may be applied to the control electrode of the first transistor T1 along a path of the second transistor T2, the first transistor T1 and the third transistor T3. By the third transistor T3 which is diode-connected, a threshold voltage of the first transistor T1 may be compensated in the data voltage VPWM.

In the pulse width modulation data writing and compensation period DR2, a voltage level of the control electrode of the first transistor T1 may be VPWM+Vth_T1. Herein, Vth_T1 may mean a threshold voltage of the first transistor T1. In the pulse width modulation data writing and compensation period DR2, when VPWM+Vth_T1 is completely stored in the control electrode of the first transistor T1, the first transistor T1 may be turned off.

Referring to FIGS. 7 and 8, in the third period DR3 subsequent to the second period DR2, the first initialization signal VST1 may have the inactive level, the second initialization signal BCB may have the active level, the first scan signal SPWM[n] may have the inactive level, the second scan signal SCCG may have the active level, the emission signal EM may have the inactive level, the sweep signal SWEEP may have the high level and the voltage outputted from the first initialization voltage terminal may have the second level VCCG.

The third period DR3 may be the constant-current voltage writing period. In the constant-current voltage writing period DR3, the ninth transistor T9 may be turned on by the second scan signal SCCG. In the constant-current voltage writing period DR3, the turned-on state of the tenth transistor T10 may be maintained.

In the constant-current voltage writing period DR3, the constant-current voltage VCCG may be applied to the control electrode of the seventh transistor T7 through the ninth transistor T9. In the constant-current voltage writing period DR3, when the constant-current voltage VCCG is applied to the control electrode of the seventh transistor T7, the seventh transistor T7 may be turned on.

Referring to FIGS. 9 and 10, in the fourth period DR4 subsequent to the third period DR3, the first initialization signal VST1 may have the inactive level, the second initialization signal BCB may have an inactive level, the first scan signal SPWM[n] may have the inactive level, the second scan signal SCCG may have the inactive level, the emission signal EM may have an active level and the sweep signal SWEEP may gradually decrease from the high level.

The fourth period DR4 may be the light emission period. In the light emission period DR4, the fourth transistor T4, the fifth transistor T5 and the eighth transistor T8 may be turned on by the emission signal EM and the seventh transistor T7 may be turned on by the constant-current voltage VCCG.

In the light emission period DR4, a current may flow along a path of the seventh transistor T7, the eighth transistor T8 and the light emitting element EE such that the light emitting element EE may emit a light.

Referring to FIGS. 11 and 12, in the fifth period DR5 subsequent to the fourth period DR4, the first initialization signal VST1 may have the inactive level, the second initialization signal BCB may have the inactive level, the first scan signal SPWM[n] may have the inactive level, the second scan signal SCCG may have the inactive level, the emission signal EM may have the active level, the sweep signal SWEEP may gradually decrease following the fourth period DR4.

The fifth period DR5 may be the light emission off period. As the sweep signal SWEEP decreases, the first transistor T1 may be turned on at a certain time point. The certain time point when the first transistor T1 is turned on may be determined by the data voltage VPWM applied to the control electrode of the first transistor T1.

When the first transistor T1 is turned on, the first power voltage VDD1 is applied to the control electrode of the seventh transistor T7 along a path of the fourth transistor T4, the first transistor and the fifth transistor T5.

When the first power voltage VDD1 is applied to the control electrode of the seventh transistor T7, the seventh transistor T7 may be turned off and the light emitting element EE may stop emitting a light.

According to an embodiment, the pixel circuit may include ten transistors and two capacitors. The pixel circuit may be driven in the pulse width modulation method, operate the internal compensation of the threshold voltage and include the relatively fewer transistors compared to the conventional pixel circuit, such that the high integration may be achieved. Thus, the pixel circuit may be applicable to an ultra-high resolution display apparatus.

In addition, at least one transistor in the pulse width modulation circuit PC and at least one transistor in the constant current generating circuit CC may be N-type transistors such that a power consumption may be reduced.

In addition, a threshold voltage compensation circuit is removed from the constant current generating circuit CC such that the number of the transistors may be reduced.

In addition, the driving transistor T1 of the pulse width modulation circuit PC and the driving transistor T7 of the constant current generating circuit CC are P-type transistors such that a mobility may be enhanced.

In addition, the second initialization voltage VAINT applied to the second electrode of the tenth transistor T10 is less than the third power voltage VSS applied to the cathode electrode of the light emitting element EE such that a black characteristic of the pixel circuit may be enhanced.

In addition, the first initialization voltage applied to the control electrode of the first transistor T1 and the constant-current voltage VCCG applied to the control electrode of the seventh transistor T7 are outputted from the same voltage terminal such that a number of transistors and a number of signal lines may be reduced.

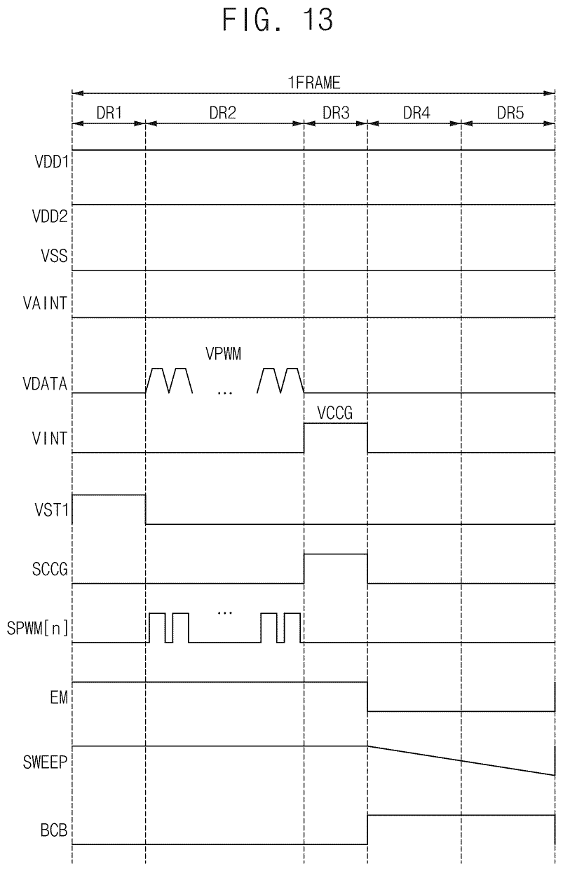

FIG. 13 is a signal timing diagram illustrating an example of input signals applied to the pixel circuit of FIG. 2 and node signals of the pixel circuit of FIG. 2.

The driving timing of the pixel circuit according to the embodiment shown in FIG. 13 is substantially the same as the driving timing of the embodiments described above referring to FIGS. 4, 6, 8, 10 and 12 except for a waveform of the second scan signal SCCG in the initialization period DR1. Thus, the same reference numerals will be used to refer to the same or like parts as those described above and any repetitive detailed description thereof will be omitted.

Referring to FIGS. 1, 2 and 13, in the driving timing, a first period DR1 may be an initialization period, a second period DR2 may be a pulse width modulation data writing and compensation period, a third period DR3 may be a constant-current voltage writing period, a fourth period DR4 may be the light emission period and a fifth period DR5 may be the light emission off period.

In the first period DR1, the first initialization signal VST1 may have an active level, the second initialization signal BCB may have an active level, the first scan signal SPWM[n] may have an inactive level, the second scan signal SCCG may have an inactive level, the emission signal EM may have an inactive level, the sweep signal SWEEP may have the high level and the voltage outputted from the first initialization voltage terminal may have the first level (the first initialization voltage).

In the second period DR2 subsequent to the first period DR1, the first initialization signal VST1 may have an inactive level, the second initialization signal BCB may have the active level, the first scan signal SPWM[n] may have an active level, the second scan signal SCCG may have the inactive level, the emission signal EM may have the inactive level and the sweep signal SWEEP may have the high level.

In the third period DR3 subsequent to the second period DR2, the first initialization signal VST1 may have the inactive level, the second initialization signal BCB may have the active level, the first scan signal SPWM[n] may have the inactive level, the second scan signal SCCG may have an active level, the emission signal EM may have the inactive level, the sweep signal SWEEP may have the high level and the voltage outputted from the first initialization voltage terminal may have the second level VCCG.

The second scan signal SCCG may have the inactive level in the first period DR1 and the second period DR2 and may have the active level in the third period DR3. In the constant-current voltage writing period DR3, the ninth transistor T9 may be turned on by the second scan signal SCCG. In the constant-current voltage writing period DR3, the constant-current voltage VCCG may be applied to the control electrode of the seventh transistor T7 through the ninth transistor T9.

According to an embodiment, the pixel circuit may include ten transistors and two capacitors. The pixel circuit may be driven in the pulse width modulation method, operate the internal compensation of the threshold voltage and include the relatively fewer transistors compared to the conventional pixel circuit, such that the high integration may be achieved. Thus, the pixel circuit may be applicable to an ultra-high resolution display apparatus.

In addition, at least one transistor in the pulse width modulation circuit PC and at least one transistor in the constant current generating circuit CC may be N-type transistors such that a power consumption may be reduced.

In addition, a threshold voltage compensation circuit is removed from the constant current generating circuit CC such that the number of the transistors may be reduced.

In addition, the driving transistor T1 of the pulse width modulation circuit PC and the driving transistor T7 of the constant current generating circuit CC are P-type transistors such that a mobility may be enhanced.

In addition, the second initialization voltage VAINT applied to the second electrode of the tenth transistor T10 is less than the third power voltage VSS applied to the cathode electrode of the light emitting element EE such that a black characteristic of the pixel circuit may be enhanced.

In addition, the first initialization voltage applied to the control electrode of the first transistor T1 and the constant-current voltage VCCG applied to the control electrode of the seventh transistor T7 are outputted from the same voltage terminal such that a number of transistors and a number of signal lines may be reduced.

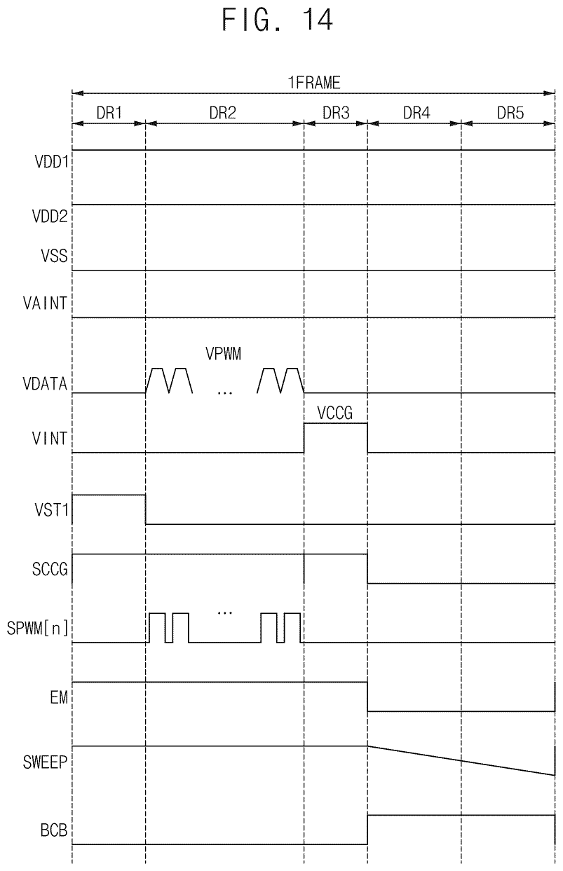

FIG. 14 is a signal timing diagram illustrating an example of input signals applied to the pixel circuit of FIG. 2 and node signals of the pixel circuit of FIG. 2.

The driving timing of the pixel circuit according to the embodiment of FIG. 14 is substantially the same as the driving timing of the embodiment described above referring to FIGS. 4, 6, 8, 10 and 12 except for a waveform of the second scan signal SCCG in the pulse width modulation data writing and compensation period DR2. Thus, the same reference numerals will be used to refer to the same or like parts as those described above and any repetitive detailed description thereof will be omitted.

Referring to FIGS. 1, 2 and 14, in the driving timing, a first period DR1 may be an initialization period, a second period DR2 may be a pulse width modulation data writing and compensation period, a third period DR3 may be a constant-current voltage writing period, a fourth period DR4 may be the light emission period and a fifth period DR5 may be the light emission off period.

In the first period DR1, the first initialization signal VST1 may have an active level, the second initialization signal BCB may have an active level, the first scan signal SPWM[n] may have an inactive level, the second scan signal SCCG may have an active level, the emission signal EM may have an inactive level, the sweep signal SWEEP may have the high level and the voltage outputted from the first initialization voltage terminal may have the first level (the first initialization voltage).

In the second period DR2 subsequent to the first period DR1, the first initialization signal VST1 may have an inactive level, the second initialization signal BCB may have the active level, the first scan signal SPWM[n] may have an active level, the second scan signal SCCG may have the active level, the emission signal EM may have the inactive level and the sweep signal SWEEP may have the high level.

In the third period DR3 subsequent to the second period DR2, the first initialization signal VST1 may have the inactive level, the second initialization signal BCB may have the active level, the first scan signal SPWM[n] may have the inactive level, the second scan signal SCCG may have the active level, the emission signal EM may have the inactive level, the sweep signal SWEEP may have the high level and the voltage outputted from the first initialization voltage terminal may have the second level VCCG.

The second scan signal SCCG may have the active level in the first period DR1, the second period DR2 and the third period DR3. In the constant-current voltage writing period DR3, the ninth transistor T9 may be turned on by the second scan signal SCCG. In the constant-current voltage writing period DR3, the constant-current voltage VCCG may be applied to the control electrode of the seventh transistor T7 through the ninth transistor T9.

According to an embodiment, the pixel circuit may include ten transistors and two capacitors. The pixel circuit may be driven in the pulse width modulation method, operate the internal compensation of the threshold voltage and include the relatively fewer transistors compared to the conventional pixel circuit, such that the high integration may be achieved. Thus, the pixel circuit may be applicable to an ultra-high resolution display apparatus.

In addition, at least one transistor in the pulse width modulation circuit PC and at least one transistor in the constant current generating circuit CC may be N-type transistors such that a power consumption may be reduced.

In addition, a threshold voltage compensation circuit is removed from the constant current generating circuit CC such that the number of the transistors may be reduced.

In addition, the driving transistor T1 of the pulse width modulation circuit PC and the driving transistor T7 of the constant current generating circuit CC are P-type transistors such that a mobility may be enhanced.

In addition, the second initialization voltage VAINT applied to the second electrode of the tenth transistor T10 is less than the third power voltage VSS applied to the cathode electrode of the light emitting element EE such that a black characteristic of the pixel circuit may be enhanced.

In addition, the first initialization voltage applied to the control electrode of the first transistor T1 and the constant-current voltage VCCG applied to the control electrode of the seventh transistor T7 are outputted from the same voltage terminal such that a number of transistors and a number of signal lines may be reduced.

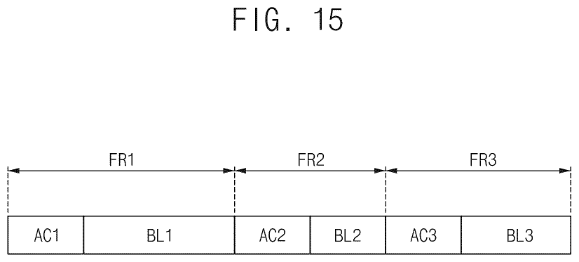

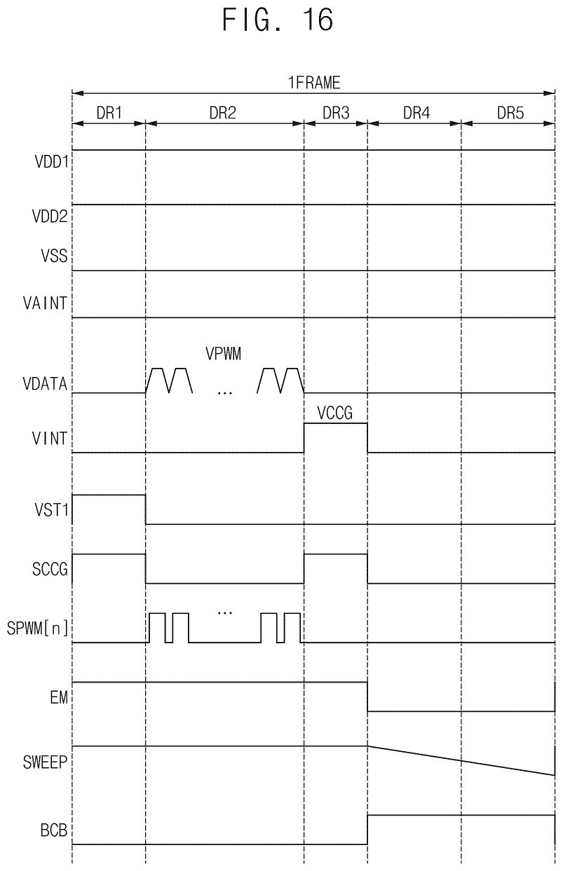

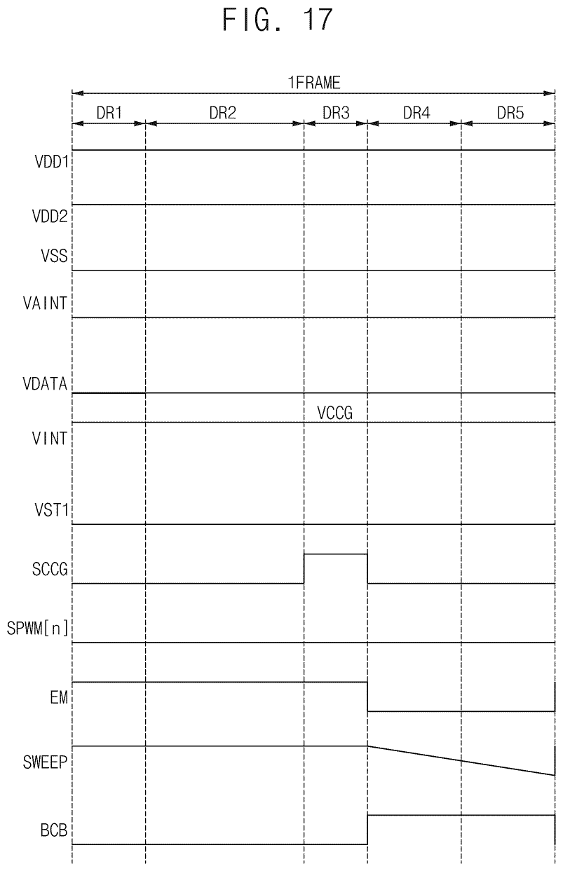

FIG. 15 is a diagram illustrating a driving frequency of the display panel 100 of FIG. 1. FIG. 16 is a signal timing diagram illustrating an example of input signals applied to the pixel circuit of FIG. 2 and node signals of the pixel circuit of FIG. 2 in a writing frame. FIG. 17 is a signal timing diagram illustrating an example of input signals applied to the pixel circuit of FIG. 2 and node signals of the pixel circuit of FIG. 2 in a holding frame.

The driving timing of the pixel circuit according to the embodiment of FIGS. 15 to 17 is substantially the same as the driving timing of the embodiment described above referring to FIGS. 4, 6, 8, 10 and 12 except that the display panel is driven in a variable frequency. Thus, the same reference numerals will be used to refer to the same or like parts as those described above and any repetitive detailed description thereof will be omitted.

Referring to FIGS. 1, 2 and 15 to 17, an embodiment of the display panel 100 may be driven in a variable frequency. A first frame FR1 having a first frequency may include a first active period AC1 and a first blank period BL1. A second frame FR2 having a second frequency different from the first frequency may include a second active period AC2 and a second blank period BL2. A third frame FR3 having a third frequency different from the first frequency and the second frequency may include a third active period AC3 and a third blank period BL3.

The first active period AC1 may have a length substantially the same as a length of the second active period AC2. The first blank period BL1 may have a length different from a length of the second blank period BL2.

The second active period AC2 may have the length substantially the same as a length of the third active period AC3. The second blank period BL2 may have the length different from a length of the third blank period BL3.

The display apparatus supporting (operable with) the variable frequency may include a writing frame (or writing period), in which the data voltage is written to the pixel, and a holding frame (or holding period), in which only light emission is operated without writing the data voltage to the pixel. The writing frame may be in the active period AC1, AC2 and AC3. The holding frame may be in the blank period BL1, BL2 and BL3.

In an embodiment, for example, in the writing frame, the data voltage VPWM may be applied to the first transistor T1 and the light emitting element EE may emit a light. In an embodiment, for example, in the holding frame, the data voltage VPWM may not be applied to the first transistor T1 and the light emitting element EE may emit a light.

In the driving timing of the writing frame of FIG. 16, the first period DR1 may be an initialization period, the second period DR2 may be a pulse width modulation data writing and compensation period, the third period DR3 may be a constant-current voltage writing period, the fourth period DR4 may be a light emission period and the fifth period DR5 may be a light emission off period. The driving timing of the writing frame of FIG. 16 may be substantially the same as the driving timings of FIGS. 4, 6, 8, 10 and 12.

In the driving timing of the holding frame of FIG. 17, the first period DR1 may be an initialization period, the second period DR2 may be a pulse width modulation data writing and compensation period, the third period DR3 may be a constant-current voltage writing period, the fourth period DR4 may be a light emission period and the fifth period DR5 may be a light emission off period. In the holding frame, the voltage VDATA of a data voltage terminal maintains a constant level, the voltage VINT of the first initialization terminal may maintain the second level VCCG and the first initialization signal VST1 may maintain an inactive level and the first scan signal SPWM[n] may maintain an inactive level. The second scan signal SCCG may have an active level in the third period DR3 and may have an inactive level in the first period DR1, the second period DR2, the fourth period DR4 and the fifth period DR5.

In the first period (DR1 of FIG. 16) of the writing frame, the first initialization signal VST1 may have an active level. In the second period (DR2 of FIG. 16) of the writing frame, the first scan signal SPWM[n] may have an active pulse. In the first period (DR1 of FIG. 17) of the holding frame in which the data voltage VPWM is not applied to the first transistor T1 and the light emitting element EE emits a light, the first initialization signal VST1 may have an inactive level. In the second period (DR2 of FIG. 17) of the holding frame, the first scan signal SPWM[n] may have an inactive level.

According to an embodiment, the pixel circuit may include ten transistors and two capacitors. The pixel circuit may be driven in the pulse width modulation method, operate the internal compensation of the threshold voltage and include the relatively fewer transistors compared to the conventional pixel circuit, such that the high integration may be achieved. Thus, the pixel circuit may be applicable to an ultra-high resolution display apparatus.

In addition, at least one transistor in the pulse width modulation circuit PC and at least one transistor in the constant current generating circuit CC may be N-type transistors such that a power consumption may be reduced.

In addition, a threshold voltage compensation circuit is removed from the constant current generating circuit CC such that the number of the transistors may be reduced.

In addition, the driving transistor T1 of the pulse width modulation circuit PC and the driving transistor T7 of the constant current generating circuit CC are P-type transistors such that a mobility may be enhanced.

In addition, the second initialization voltage VAINT applied to the second electrode of the tenth transistor T10 is less than the third power voltage VSS applied to the cathode electrode of the light emitting element EE such that a black characteristic of the pixel circuit may be enhanced.

In addition, the first initialization voltage applied to the control electrode of the first transistor T1 and the constant-current voltage VCCG applied to the control electrode of the seventh transistor T7 are outputted from the same voltage terminal such that a number of transistors and a number of signal lines may be reduced.

In addition, in an embodiment, the pixel circuit may support a variable frequency driving method such that the power consumption of the display apparatus may be reduced.

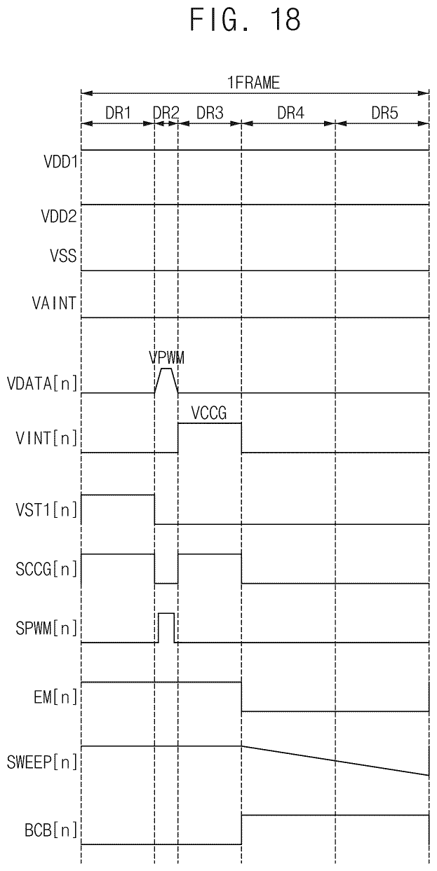

FIG. 18 is a signal timing diagram illustrating an example of input signals applied to the pixel circuit of FIG. 2 and node signals of the pixel circuit of FIG. 2.

The driving timing of the pixel circuit according to the embodiment of FIG. 18 is substantially the same as the driving timing of the embodiment described above referring to FIGS. 4, 6, 8, 10 and 12 except that the display panel is driven in a progressive light emission driving method. Thus, the same reference numerals will be used to refer to the same or like parts as those described above and any repetitive detailed description thereof will be omitted.

Referring to FIGS. 1, 2 and 18, an embodiment of the display panel 100 may be driven in a progressive light emission driving method.

In a driving timing, a first period DR1 may be an initialization period, a second period DR2 may be a pulse width modulation data writing and compensation period, a third period DR3 may be a constant-current voltage writing period, a fourth period DR4 may be a light emission period and a fifth period DR5 may be a light emission off period.

In an embodiment, the first initialization signal VST1 [n], the second initialization signal BCB[n], the first scan signal SPWM[n], the second scan signal SCCG [n], the emission signal EM[n] and the sweep signal SWEEP [n] may be progressive scan signals having different timings for pixel rows. Herein, [n] represents an n-th pixel row.

The first initialization signal VST1[n], the second initialization signal BCB[n], the first scan signal SPWM[n], the second scan signal SCCG[n], the emission signal EM[n] and the sweep signal SWEEP[n] may be progressively or sequentially applied to the pixel rows.

In addition, the voltage VDATA[n] of the data voltage terminal and the voltage VINT[n] of the first initialization voltage terminal may be progressively or sequentially applied to the pixel rows.

According to an embodiment, the pixel circuit may include ten transistors and two capacitors. The pixel circuit may be driven in the pulse width modulation method, operate the internal compensation of the threshold voltage and include the relatively fewer transistors compared to the conventional pixel circuit, such that the high integration may be achieved. Thus, the pixel circuit may be applicable to an ultra-high resolution display apparatus.

In addition, at least one transistor in the pulse width modulation circuit PC and at least one transistor in the constant current generating circuit CC may be N-type transistors such that a power consumption may be reduced.

In addition, a threshold voltage compensation circuit is removed from the constant current generating circuit CC such that the number of the transistors may be reduced.

In addition, the driving transistor T1 of the pulse width modulation circuit PC and the driving transistor T7 of the constant current generating circuit CC are P-type transistors such that a mobility may be enhanced.

In addition, the second initialization voltage VAINT applied to the second electrode of the tenth transistor T10 is less than the third power voltage VSS applied to the cathode electrode of the light emitting element EE such that a black characteristic of the pixel circuit may be enhanced.

In addition, the first initialization voltage applied to the control electrode of the first transistor T1 and the constant-current voltage VCCG applied to the control electrode of the seventh transistor T7 are outputted from the same voltage terminal such that a number of transistors and a number of signal lines may be reduced.

In addition, in the embodiment, the pixel circuit may be driven in the progressive light emission driving method.

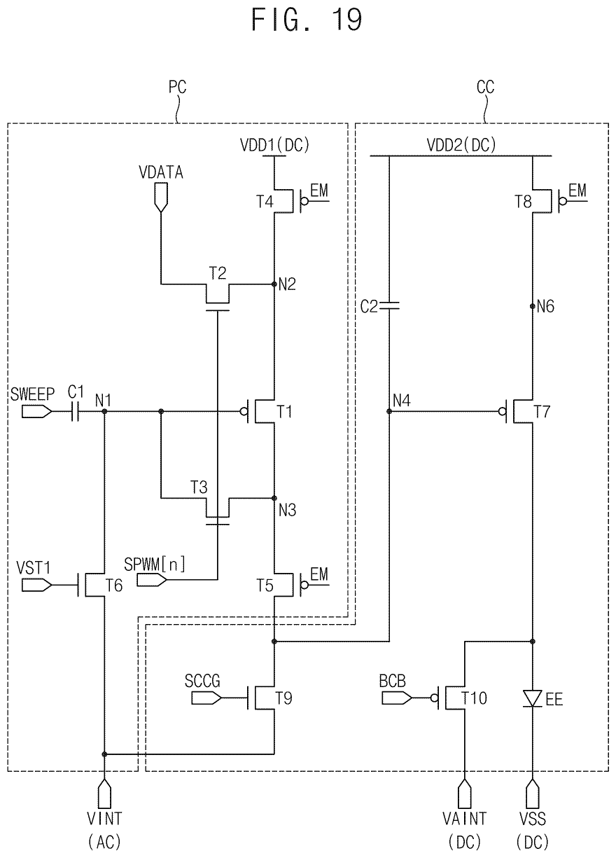

FIG. 19 is a circuit diagram illustrating a pixel circuit of a display panel 100 of a display apparatus according to an embodiment of the invention.

The pixel circuit according to the embodiment of FIG. 19 is substantially the same as the pixel circuit of the embodiment described above referring to FIG. 2 except for a connection of the eighth transistor. Thus, the same reference numerals will be used to refer to the same or like parts as those described above and any repetitive detailed description thereof will be omitted.

Referring to FIGS. 1, 3 to 12 and 19, an embodiment of the pixel circuit includes the first transistor T1, the second transistor T2, the third transistor T3, the seventh transistor T7, the ninth transistor T9 and the light emitting element EE. The first transistor T1 includes a control electrode connected to a first node N1, a first electrode connected to a second node N2 and a second electrode connected to a third node N3. The second transistor T2 applies a data voltage (VPWM of FIG. 4) to the first transistor T1. The third transistor T3 is connected to the first node N1 and the third node N3. The seventh transistor T7 is connected to a fourth node N4 and applies a driving current to the light emitting element EE. The ninth transistor T9 applies a constant-current voltage (VCCG of FIG. 4) to the fourth node N4. The light emitting element EE emits a light based on the data voltage (VPWM of FIG. 4) and the constant-current voltage (VCCG of FIG. 4).

The first transistor T1 is a P-type transistor. The seventh transistor T7 is a P-type transistor. The second transistor T2 is an N-type transistor. The third transistor T3 is an N-type transistor.

The eighth transistor T8 may include a control electrode that receives the emission signal EM, a first electrode that receives a second power voltage VDD2 and a second electrode connected to a sixth node N6.

The seventh transistor T7 may include a control electrode connected to the fourth node N4, a first electrode connected to the sixth node N6 and a second electrode connected to an anode electrode of the light emitting element EE.

According to an embodiment, the pixel circuit may include ten transistors and two capacitors. The pixel circuit may be driven in the pulse width modulation method, operate the internal compensation of the threshold voltage and include the relatively fewer transistors compared to the conventional pixel circuit, such that the high integration may be achieved. Thus, the pixel circuit may be applicable to an ultra-high resolution display apparatus.

In addition, at least one transistor in the pulse width modulation circuit PC and at least one transistor in the constant current generating circuit CC may be N-type transistors such that a power consumption may be reduced.

In addition, a threshold voltage compensation circuit is removed from the constant current generating circuit CC such that the number of the transistors may be reduced.

In addition, the driving transistor T1 of the pulse width modulation circuit PC and the driving transistor T7 of the constant current generating circuit CC are P-type transistors such that a mobility may be enhanced.

In addition, the second initialization voltage VAINT applied to the second electrode of the tenth transistor T10 is less than the third power voltage VSS applied to the cathode electrode of the light emitting element EE such that a black characteristic of the pixel circuit may be enhanced.

In addition, the first initialization voltage applied to the control electrode of the first transistor T1 and the constant-current voltage VCCG applied to the control electrode of the seventh transistor T7 are outputted from the same voltage terminal such that a number of transistors and a number of signal lines may be reduced.

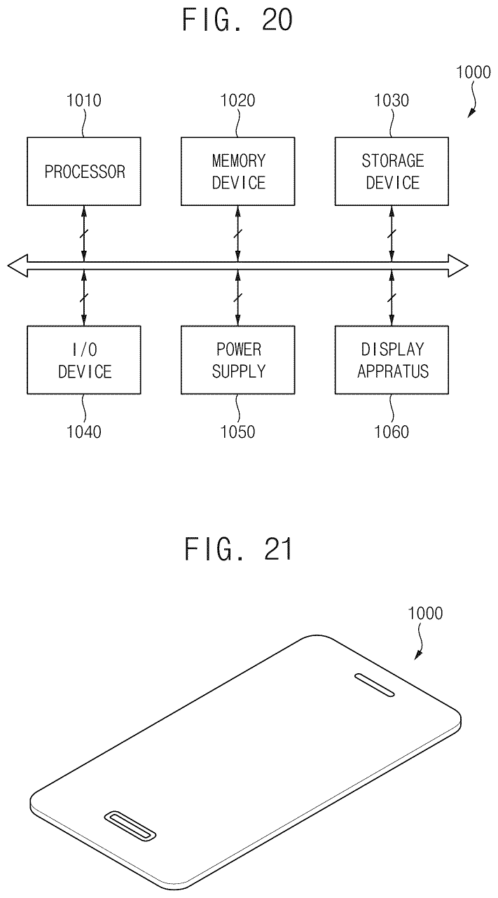

FIG. 20 is a block diagram illustrating an electronic apparatus 1000 according to an embodiment of the invention. FIG. 21 is a diagram illustrating an example in which the electronic apparatus 1000 of FIG. 20 is implemented as a smart phone.

Referring to FIGS. 20 and 21, an embodiment of the electronic apparatus 1000 may include a processor 1010, a memory device 1020, a storage device 1030, an input/output (I/O) device 1040, a power supply 1050 and a display apparatus 1060. Here, the display apparatus 1060 may be the display apparatus of FIG. 1. In addition, the electronic apparatus 1000 may further include a plurality of ports for communicating with a video card, a sound card, a memory card, a universal serial bus (USB) device, other electronic apparatuses, etc.

In an embodiment, as illustrated in FIG. 21, the electronic apparatus 1000 may be implemented as a smart phone. However, the electronic apparatus 1000 is not limited thereto. For example, the electronic apparatus 1000 may be implemented as a cellular phone, a video phone, a smart pad, a smart watch, a tablet computer, a car navigation system, a computer monitor, a laptop, a head mounted display (HMD) device, or the like.

The processor 1010 may perform various computing functions or various tasks. The processor 1010 may be a micro-processor, a central processing unit (CPU), an application processor (AP), or the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data IMG and the input control signal CONT to the driving controller 200 of FIG. 1.

The memory device 1020 may store data for operations of the electronic apparatus 1000. In an embodiment, for example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, or the like and/or at least one volatile memory device such as a dynamic random access memory (DRAM) device, a static random access memory (SRAM) device, a mobile DRAM device, or the like.

The storage device 1030 may include a solid state drive (SSD) device, a hard disk drive (HDD) device, a CD-ROM device, or the like. The I/O device 1040 may include an input device such as a keyboard, a keypad, a mouse device, a touch-pad, a touch-screen, or the like and an output device such as a printer, a speaker, or the like. In some embodiments, the display apparatus 1060 may be included in the I/O device 1040. The power supply 1050 may provide power for operations of the electronic apparatus 1000. The display apparatus 1060 may be coupled to other components via the buses or other communication links.

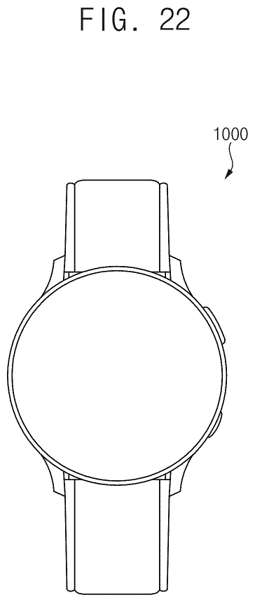

FIG. 22 is a diagram illustrating an example in which the electronic apparatus 1000 of FIG. 20 is implemented as a smart watch.

Referring to FIGS. 20 and 22, an embodiment of the electronic apparatus 1000 may be implemented as a smart watch. The smart watch may be an example of the electronic apparatus 1000 desired to include an ultra-high resolution display panel.

In the pixel circuit and the display apparatus according to embodiments of the invention as described above, the ultra-high resolution display apparatus may be implemented using the pixel circuit having the high integration.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A pixel circuit comprising:
a first transistor including a control electrode connected to a first node, a first electrode connected to a second node and a second electrode connected to a third node;
a second transistor which applies a data voltage to the first transistor;
a third transistor connected to the first node and the third node;
a seventh transistor connected to a fourth node, wherein the seventh transistor applies a driving current to a light emitting element;
a ninth transistor which applies a constant-current voltage to the fourth node; and
the light emitting element which emits a light based on the data voltage and the constant-current voltage,
wherein the first transistor is a P-type transistor,
wherein the second transistor is an N-type transistor,
wherein the third transistor is an N-type transistor, and
wherein the seventh transistor is a P-type transistor.

2. The pixel circuit of claim 1, further comprising a sixth transistor including a control electrode which receives a first initialization signal, a first electrode connected to the first node and a second electrode connected to a first initialization voltage terminal.

3. The pixel circuit of claim 1, further comprising a first capacitor including a first electrode which receives a sweep signal and a second electrode connected to the first node.

4. The pixel circuit of claim 1, further comprising:
a fourth transistor including a control electrode which receives an emission signal, a first electrode which receives a first power voltage and a second electrode connected to the second node; and
a fifth transistor including a control electrode which receives the emission signal, a first electrode connected to the third node and a second electrode connected to the fourth node.

5. The pixel circuit of claim 1, further comprising an eighth transistor including a control electrode which receives an emission signal, a first electrode connected to a second electrode of the seventh transistor and a second electrode connected to an anode electrode of the light emitting element.

6. The pixel circuit of claim 1, further comprising an eighth transistor including a control electrode which receives an emission signal, a first electrode which receives a second power voltage and a second electrode connected to a first electrode of the seventh transistor.

7. The pixel circuit of claim 1, further comprising a tenth transistor including a control electrode which receives a second initialization signal, a first electrode connected to an anode electrode of the light emitting element and a second electrode which receives a second initialization voltage.

8. The pixel circuit of claim 1, further comprising a second capacitor including a first electrode which receives a second power voltage and a second electrode connected to the fourth node.

9. The pixel circuit of claim 1, wherein the second transistor includes a control electrode which receives a first scan signal, a first electrode which receives the data voltage and a second electrode connected to the second node;
wherein the third transistor includes a control electrode which receives the first scan signal, a first electrode connected to the first node and a second electrode connected to the third node,
wherein the seventh transistor includes a control electrode connected to the fourth node, a first electrode which receives a second power voltage and a second electrode connected to a fifth node,
wherein the ninth transistor includes a control electrode which receives a second scan signal, a first electrode connected to the fourth node and a second electrode connected to a first initialization voltage terminal,
wherein the light emitting element includes an anode electrode connected to the fifth node and a cathode electrode which receives a third power voltage,
wherein the pixel circuit further comprises:
a fourth transistor including a control electrode which receives an emission signal, a first electrode which receives a first power voltage and a second electrode connected to the second node;
a fifth transistor including a control electrode which receives the emission signal, a first electrode connected to the third node and a second electrode connected to the fourth node;
a sixth transistor including a control electrode which receives a first initialization signal, a first electrode connected to the first node and a second electrode connected to the first initialization voltage terminal;
an eighth transistor including a control electrode which receives the emission signal, a first electrode connected to the fifth node and a second electrode connected to the anode electrode of the light emitting element;
a tenth transistor including a control electrode which receives a second initialization signal, a first electrode connected to the anode electrode of the light emitting element and a second electrode which receives a second initialization voltage;
a first capacitor including a first electrode which receives a sweep signal and a second electrode connected to the first node; and
a second capacitor including a first electrode which receives the second power voltage and a second electrode connected to the fourth node.

10. The pixel circuit of claim 9, wherein the sixth transistor and the ninth transistor are N-type transistors, and
wherein the fourth transistor, the fifth transistor, the eighth transistor and the tenth transistor are P-type transistors.

11. The pixel circuit of claim 9, wherein the first initialization signal has an active level in a first period,
wherein the second initialization signal has an active level in the first period,
wherein the first scan signal has an inactive level in the first period,
wherein the second scan signal has an active level in the first period,
wherein the emission signal has an inactive level in the first period,
wherein the sweep signal has a high level in the first period, and
wherein a voltage outputted from the first initialization voltage terminal has a first level in the first period.

12. The pixel circuit of claim 9, wherein the first initialization signal has an inactive level in a second period,
wherein the second initialization signal has an active level in the second period,
wherein the first scan signal has an active pulse in the second period,
wherein the second scan signal has an inactive level in the second period,
wherein the emission signal has an inactive level in the second period, and
wherein the sweep signal has a high level in the second period.

13. The pixel circuit of claim 9, wherein the first initialization signal has an inactive level in a third period,
wherein the second initialization signal has an active level in the third period,
wherein the first scan signal has an inactive level in the third period,
wherein the second scan signal has an active level in the third period,
wherein the emission signal has an inactive level in the third period,
wherein the sweep signal has a high level in the third period, and
wherein a voltage outputted from the first initialization voltage terminal has a second level in the third period.

14. The pixel circuit of claim 9, wherein the first initialization signal has an inactive level in a fourth period and a fifth period,
wherein the second initialization signal has an inactive level in the fourth period and the fifth period,
wherein the first scan signal has an inactive level in the fourth period and the fifth period,
wherein the second scan signal has an inactive level in the fourth period and the fifth period,
wherein the emission signal has an active level in the fourth period and the fifth period, and
wherein the sweep signal gradually decreases from a high level in the fourth period and the fifth period.

15. The pixel circuit of claim 9, wherein the second scan signal has an inactive level in a first period,
wherein the second scan signal has the inactive level in a second period subsequent to the first period, and
wherein the second scan signal has an active level in a third period subsequent to the second period.

16. The pixel circuit of claim 9, wherein the second scan signal has an active level in a first period,
wherein the second scan signal has the active level in a second period subsequent to the first period, and
wherein the second scan signal has the active level in a third period subsequent to the second period.

17. The pixel circuit of claim 9, wherein the data voltage is applied to the first transistor and the light emitting element emits a light in a writing frame,
wherein the first initialization signal has an active level in a first period of the writing frame,
wherein the first scan signal has an active pulse in a second period of the writing frame,
wherein the data voltage is not applied to the first transistor and the light emitting element emits a light in a holding frame,
wherein the first initialization signal has an inactive level in a first period of the holding frame, and
wherein the first scan signal has an inactive level in a second period of the holding frame.

18. The pixel circuit of claim 9, wherein the first initialization signal, the second initialization signal, the first scan signal, the second scan signal, the emission signal and the sweep signal are sequentially applied to pixel rows.

19. The pixel circuit of claim 1, further comprising a fourth transistor including a control electrode which receives an emission signal, a first electrode which receives a first power voltage and a second electrode connected to the second node,
wherein a second power voltage is applied to a first electrode of the seventh transistor,
wherein the first power voltage is greater than the second power voltage,
further comprising a tenth transistor including a control electrode which receives a second initialization voltage, a first electrode connected to an anode electrode of the light emitting element and a second electrode which receives a second initialization voltage,
wherein a third power voltage is applied to a cathode electrode of the light emitting element, and
wherein the second initialization voltage is less than the third power voltage.

20. A display apparatus comprising:
a display panel including a pixel circuit;
a gate driver which outputs a gate signal to the pixel circuit; and
a data driver which outputs a data voltage to the pixel circuit,
wherein the pixel circuit comprises:
a first transistor including a control electrode connected to a first node, a first electrode connected to a second node and a second electrode connected to a third node;
a second transistor which applies the data voltage to the first transistor;
a third transistor connected to the first node and the third node;
a seventh transistor connected to a fourth node, wherein the seventh transistor applies a driving current to a light emitting element;
a ninth transistor which applies a constant-current voltage to the fourth node; and
the light emitting element which emits a light based on the data voltage and the constant-current voltage,
wherein the first transistor is a P-type transistor,
wherein the second transistor is an N-type transistor,
wherein the third transistor is an N-type transistor, and
wherein the seventh transistor is a P-type transistor.

21. An electronic device comprising:
a display panel including a pixel circuit;
a gate driver which outputs a gate signal to the pixel circuit; and
a data driver which outputs a data voltage to the pixel circuit,
wherein the pixel circuit comprises:
a first transistor including a control electrode connected to a first node, a first electrode connected to a second node and a second electrode connected to a third node;
a second transistor which applies the data voltage to the first transistor;
a third transistor connected to the first node and the third node;
a seventh transistor connected to a fourth node, wherein the seventh transistor applies a driving current to a light emitting element;
a ninth transistor which applies a constant-current voltage to the fourth node; and
the light emitting element which emits a light based on the data voltage and the constant-current voltage,
wherein the first transistor is a P-type transistor,
wherein the second transistor is an N-type transistor,
wherein the third transistor is an N-type transistor, and
wherein the seventh transistor is a P-type transistor.
